(19) United States
(12) Patent Application Publication
(10) Pub. No.: US 2022/0322031 A1
(43) Pub. Date: Oct. 6, 2022

(54) PROOF OF LOCATION USING PROXIMITY RECORDS AND DISTRIBUTED LEDGER

(71) Applicant: Intel Corporation, Santa Clara, CA (US)

(72) Inventors: Roy L. Doyal, Chandler, AZ (US); Robert L. Vaughn, Portland, OR (US); Ned M. Smith, Beaverton, OR (US); William C, Deleeuw, Beaverton, OR (US)

(21) Appl. No.: 17/840,408

(22) Filed: Jun. 14, 2022

Related U.S. Application Data
(62) Division of application No. 15/706,439, filed on Sep. 15, 2017.

(51) Int. Cl. H04W 4/02; G06Q 20/32; G06F 16/29; G06Q 20/38

(52) U.S. Cl. CPC H04W 4/023; G06Q 20/3224; G06F 16/29; G06Q 20/327; G06Q 20/389; G06Q 2220/00

(57) ABSTRACT

Apparatuses, methods and storage media associated with proof of location are disclosed herewith. In embodiments, an apparatus may include communication circuitry configured to communicate with one or more external servers jointly hosting a distributed ledger of proximal device records, and posting circuitry configured to post records of sharing of a proximity record of the apparatus with one or more other apparatuses located proximally to the apparatus, and records of receipts of proximity records of the other proximally located apparatuses from the other proximally located apparatuses, into the distributed ledger. The proximity records posted into the distributed ledger may be used to prove the apparatus's location. Additionally, other embodiments, including a participating host server of a distributed ledger or a server of a product/service provider, are also disclosed.

### TECHNICAL FIELD

The present disclosure relates to the field of computing, in particular, to apparatuses, methods and storage media associated with proof of location using proximity records and distributed ledger.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Increasingly, it is desirable to be able to consider location information as a factor of authentication. Currently the two popular approaches to determining a user's location are probably the approaches used by Google® and Apple® Computer. Both companies use a variety of methods (Global Positioning System (GPS), WiFi scanning, Internet Protocol (IP) address resolution, cross-correlation, etc.) to determine where users are located. However, the locations so determined are generally not considered to be sufficiently reliable to be used as a factor of authentication. In part, it may be because existing methods merely provide only circumstantial information about the users' locations and the private location information are necessarily shared with third parties, rendering them susceptible to spoofing.

For example, GPS information can be easily spoofed, by simply injecting GPS coordinates into the requesting application. In the case of iBeacon or BLE Beacons, they may require a web service to authenticate a given beacon in order to know its meaning and trust it is not spoofed. For WiFi scanning, Wifi names (SSIDs, etc.) can be duplicated in a secondary location to spoof location information, and WiFi AP topology is constantly changing with many AP's becoming mobile. For IP address resolution, with network address translation (NAT) commonly known and used, IP address resolution is often incorrect. Proxies and other networking technologies may act to hide the true IP of a given device. For Dead Reckoning—the use of accelerometers, gyros, and/or magnetometer to estimate path traveled from a known point tend to diverge over time and over space, such that it may not be trusted without a periodic absolute position reference. Lastly, for cross-correlation, utilizing some or all of the aforementioned methods does little to increase trust or proof of a device's location.

As a result, today, location information is generally not well trusted as a security/authentication factor, nor as sufficiently private.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an overview of an example computing/communication arrangement with the proof of location technology of the present disclosure, in accordance with various embodiments.

FIG. 2 illustrates an overview of another example computing/communication arrangement with the proof of location technology of the present disclosure, in accordance with various embodiments.

FIG. 3 illustrates an overview of yet another example computing/communication arrangement with the proof of location technology of the present disclosure, in accordance with various embodiments.

FIG. 4 illustrates illustrate a component view of an example mobile device, in accordance with various embodiments.

FIG. 5 illustrates illustrate a component view of an example participating host server of a distributed ledger, in accordance with various embodiments.

FIG. 6 illustrates illustrate a component view of an example server of a product or service provider, in accordance with various embodiments.

FIG. 7 illustrates an example process for proving location, in accordance with various embodiments.

FIG. 8 illustrates example proximity device graph, in accordance with various embodiments.

FIG. 9 illustrates an example computing device, suitable for use as a mobile device, a distributed ledger host server or a server of a product or service provider, in accordance with various embodiments.

FIG. 10 illustrates an example storage medium with instructions configured to enable a mobile device, a distributed ledger host server or a server of a product or service provider to practice the present disclosure, in accordance with various embodiments.

### DETAILED DESCRIPTION

Apparatuses, methods and storage media associated with proof of location are disclosed herewith. In embodiments, an apparatus, e.g., a mobile device, may include communication circuitry and posting circuitry. The communication circuitry may be configured to communicate with one or more external servers jointly hosting a distributed ledger of proximal device records. The posting circuitry may be coupled with the communication circuitry, and configured to post records of sharing of a proximity record of the apparatus with one or more other apparatuses located proximally to the apparatus, and records of receipts of proximity records of the other proximally located apparatuses from the other proximally located apparatuses, into the distributed ledger. The proximity records posted into the distributed ledger may be used to prove the apparatus's location.

In embodiments, a server for jointly hosting with other servers a distributed ledger of proximity records may include communication circuitry, storage and distributed ledger circuitry. The communication circuitry may be configured to communicate with an apparatus, e.g., a mobile device, and the storage may be configured to store some of the proximity records. The distributed ledger circuitry coupled to the communication circuitry and the storage may be configured to store into the storage, a record of sharing of a proximity record of the apparatus, and records of receipts of proximity records of other apparatuses proximally located to apparatus, by the apparatus, from the other proximally located apparatuses posted by the apparatus into the distributed ledger. As noted earlier, the proximity records posted into the distributed ledger by the apparatus may be used to prove the location of the apparatus.

In embodiments, a server for providing a product or a service may include communication circuitry and transaction circuitry. The communication circuitry may be configured to communicate with an apparatus, e.g., a mobile device. The transaction circuitry may be coupled to the communication circuitry and configured to conduct a transaction with the apparatus. In particular, the transaction circuitry may be configured to receive a proximity device graph from the apparatus, and to retrieve proximity records underlying the proximity device graph, from one or more servers jointly hosting a distributed ledger of proximity records, to prove the apparatus's location. The underlying proximity records have been previously posted to the distributed ledger by the apparatus, prior to the apparatus engaging the server in the transaction.

These and other aspects of the disclosure will be described below with references to the drawings. In the description to follow, reference is made to the accompanying drawings, which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Operations of various methods may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiments. Various additional operations may be performed and/or described operations may be omitted, split or combined in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous. The term Internet of Things (IoT) as used herein refers to the inter-networking of physical devices, vehicles (also referred to as “connected devices” and “smart devices”), buildings, and other items embedded with electronics, software, sensors, actuators, and network connectivity which enable these objects to collect and exchange data.

As used hereinafter, including the claims, the term “module” may refer to, be part of, or include an Application Specific Integrated Circuit (ASIC), an electronic circuit, a programmable combinational logic circuit (e.g., field programmable gate arrays (FPGA)), a processor (shared, dedicated, or group) and/or memory (shared, dedicated, or group) that execute one or more software or firmware programs generated from a plurality of programming instructions and/or other suitable components that provide the described functionality.

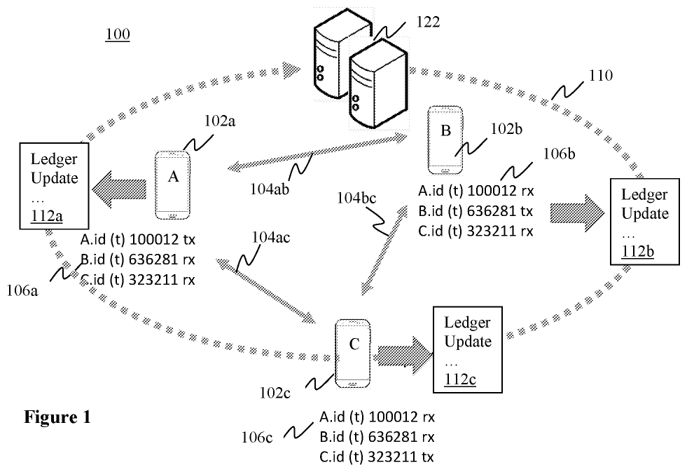

Referring now FIG. 1, wherein an overview of an example computing/communication arrangement with the proof of location technology of the present disclosure, in accordance with various embodiments, is shown. As illustrated, computing/communication environment 100 may include a number of mobile devices 102a-102b and a number of servers 122. Mobile devices 102a-102c may be located at one set of physical locations at a point in time, and move, and be located in another set of physical locations at another point in time. Servers 122 may be configured to jointly host a distributed ledger 110, graphically denoted as a ring in FIG. 1.

Each of mobile devices 102a-102c may be configured with the proof of location technology of the present disclosure. In particular, each of mobile devices 102a-102c may be configured to broadcast or share 104a-104c a proximity record with other proximally located devices, e.g., in the form of a beacon. Thus, in an instance in time, when mobile devices 102a-102c are proximally located with one another, mobile device 102a may receive proximity records shared by mobile device 102b and mobile device 102c. Similarly, mobile device 102b may receive proximity records shared by mobile device 102a and mobile device 102c, and mobile device 102c may receive proximity records shared by mobile device 102a and mobile device 102b.

For the purpose of this Specification, including the Claims, mobile devices 102a-102c are said to be proximally located with one another, when they are able to receive the broadcast of the other mobile devices. In embodiments, the communication methodology and protocols employ by mobile devices 102a-102c may be application dependent, i.e., varies from embodiments to embodiments. Therefore, the physical distances between mobile devices 102a-102c may vary from embodiments to embodiments. For example, in one embodiment, mobile devices 102a-102c may broadcast their proximity records in WiFi, while in other embodiments, mobile devices 102a-102c may broadcast their proximity records in accordance with LTE or in Bluetooth®.

Still referring to FIG. 1, additionally, each of mobile devices 102a-102c may be configured to maintain a journal 106a-106c of its broadcast/sharing of its proximity records, and receipts of proximity records of other proximally located devices. In other words, journal 106a of mobile device 102a may include the journal entries that indicate receipts of proximity records broadcast/shared by mobile devices 102b and 102c, whereas, journal 106b of mobile device 102b may include the journal entries that indicate receipts of proximity records broadcast/shared by mobile devices 102a and 102c, and journal 106c of mobile device 102c may include the journal entries that indicate receipts of proximity records broadcast/shared by mobile devices 102a and 102b.

Further, each of mobile devices 102a-102c may be configured to independently post its journal 106a-106c of its broadcast/sharing of its proximity records, and receipts of proximity records of other proximally located devices to distributed ledger 110, e.g., mobile device 102a posting ledger update 112a, mobile device 102b posting ledger update 112b, and mobile device 102c posting ledger update 112c. Given journals 106a-106c are independently posted into distributed ledger 110, and their journal entries contain overlapping information that can serve to mutually attest to the veracity and reliability of the other journal entries, the posted journal entries may be trusted and used as a factor of authentication, e.g., in a product or service transaction, such as a financial transaction.

In embodiments, the proximity records broadcast/shared by mobile devices 102a-102c (and their journal entries) may include identity tokens of mobile devices 102a-102c, e.g., “100012,” for mobile device 102a, “626281” for mobile device 102b, and “323211” for mobile device 102c. In embodiments, each mobile devices 102a-102c may be configured to generate its own identity token. In embodiments, proximity records broadcast/shared by mobile devices 102a-102c (and their journal entries) may further include the time of broadcast or sharing (not shown). In embodiments, the proximity records may be broadcast/shared in an encrypted form using a secure communication protocol, to provide privacy. In embodiments, journal entries of the proximity records broadcast/shared and received may include metadata (e.g., tx and rx) that indicate whether the proximity records are sharing (tx) records or receipt (rx) records.

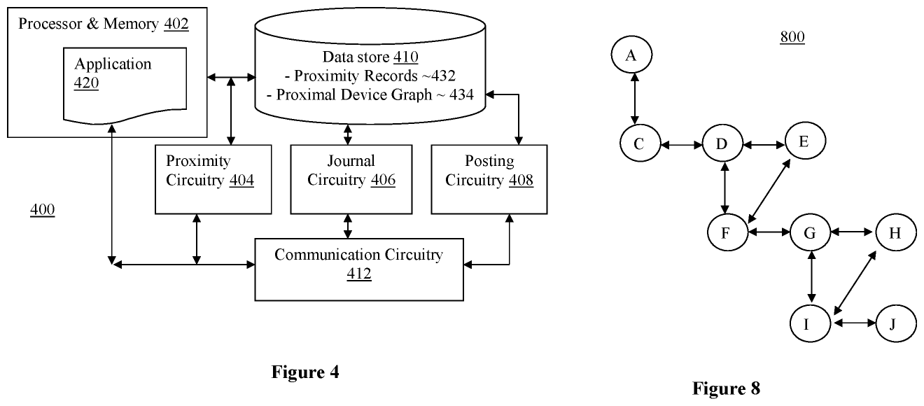

Continuing to refer to FIG. 1, while for ease of understanding, mobile device 102a-102c are illustrated as smartphones in FIG. 1, the illustration is not to be construed as limiting. In embodiments, mobile device 102a-102c may be wearable devices, IoT devices, computing tablets, laptops, autonomous vehicles, unmanned aerial vehicles (UAV), robots, and so forth. Example embodiments of mobile devices 102a-102c will be further described below with references to FIG. 4. Further, it should be noted, while for ease of understanding, three mobile devices 102a-102c are illustrated in FIG. 1, the present disclosure is not so limited. The proof of location technology of the present disclosure may be practiced with any number of mobile devices, subject only to the computing capacity of servers 122 hosting distributed ledger 110, and bandwidth of the communication/networking infrastructure coupling mobile devices 102a-102c and servers 122.

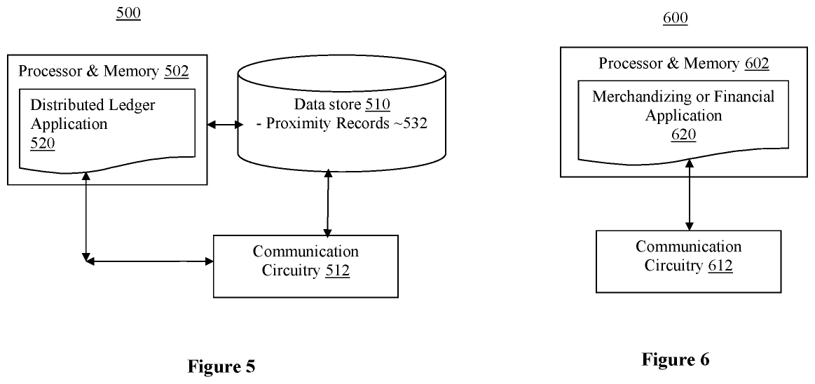

Similarly, while two adjacent servers 122 are illustrated in FIG. 1 as participating host servers to jointly host distributed ledger 110, the illustration is not to be construed as limiting. In embodiments, many servers 122 may be employed to jointly host distributed ledger 110. Servers 122 may be geographically dispersed in different physical locations. Any one of servers 122 may be a dedicated or shared server, a stationary or mobile device. In embodiments, servers 122 may jointly host distributed ledger 110 as a blockchain. Example embodiments of servers 122 will be further described below with references to FIG. 5. Examples of blockchain may include but are not limited to, Public blockchains (i.e. Bitcoin, Ethereum), Consortium blockchains (i.e. R3), Private blockchains (i.e. Eris, Multichain). Example sponsors of blockchain may include, but are not limited to Bitcoin, Ethereum, Dash, Lisk, Steem, Ripple and so forth.

As those skill in the art would appreciate, the reliability of the proximity records posted in distributed ledger 110 increases as more mobile devices independently posed their respective journals into distributed ledger 110 to cross witness or attest for each other. Distributed ledger may become a record of all observed activity and enables after-the-fact verification of an assertion such as ‘I was at the bank at noon today’. If it's 12:01, that assertion of being at the bank at noon may be quite valuable. If it's three days later, such an assertion may be thought of as an alibi with evidence.

Further, it is difficult for attackers to manipulate the independently posed proximity records, especially with large number of participants. An observer of distributed ledger 110 will not be able to tell what each number means and how it relates to the other number. Having the seed information for a specific device or individual enables an observer of distributed ledger 110 to identify that specific entity within its ledger to the extent that ledger entries represent times and places scoped by the seeds provided to the observer.

A value proposition of the disclosed technique is that a user may emit anonymous and private location evidence, such evidence may be gathered by observers and/or entered directly into a distributed ledger 110, and such evidence becomes immutable due to distributed ledger signing/hashing.

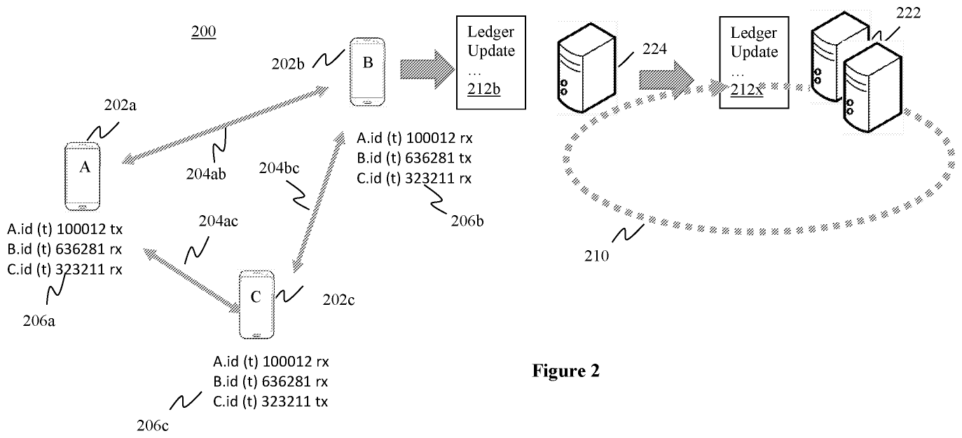

Referring now to FIG. 2, wherein an overview of another example computing/communication arrangement with the proof of location technology of the present disclosure, in accordance with various embodiments, is shown. As illustrated, computing/communication environment 200 may include a number of mobile devices 202a-202b, a number of servers 222 and at least one intermediate server 224. Mobile devices 202a-202c may be similar to mobile device 102a-102c, i.e., located at one set of physical locations at a point in time, and move, and be located in another set of physical locations at another point in time. Servers 222 may be, similar to servers 122, configured to jointly host a distributed ledger 210, also graphically denoted as a ring in FIG. 2.

Each of mobile devices 202a-202c, similar to mobile devices 102a-102c, may be configured with the proof of location technology of the present disclosure. In particular, each of mobile devices 202a-202c may be configured to broadcast or share 204a-204c a proximity record with other proximally located devices. Thus, in an instance of time, when mobile devices 202a-202c are proximally located with one another, mobile device 202a may receive proximity records shared by mobile device 202b and mobile device 202c. Similarly, mobile device 202b may receive proximity records shared by mobile device 202a and mobile device 202c, and mobile device 202c may receive proximity records shared by mobile device 202a and mobile device 202b.

Similar to mobile devices 102a-102c, each of mobile devices 202a-202c may be configured to maintain a journal 206a-206c of its broadcast/sharing of its proximity records, and receipts of proximity records of other proximally located devices. In other words, journal 206a of mobile device 202a may include the journal entries that indicate receipts of proximity records broadcast/shared by mobile devices 202b and 202c, whereas, journal 206b of mobile device 202b may include the journal entries that indicate receipts of proximity records broadcast/shared by mobile devices 202a and 202c, and journal 206c of mobile device 202c may include the journal entries that indicate receipts of proximity records broadcast/shared by mobile devices 202a and 202b.

However, unlike computing/communication arrangement 100, in arrangement 200, only a subset of mobile devices 202a-202c would independently post its journal 206a-206c of its broadcast/sharing of its proximity records, and receipts of proximity records of other proximally located devices to distributed ledger 210. For ease of understanding, only mobile device 202b is illustrated as posting ledger update 212b to distributed ledger 210. Further, mobile device 202b is illustrated as posting ledger update 212b to distributed ledger 210 via intermediate server 224.

Thus, while the reliability of the proximity records posted in distributed ledger 210 increases as more mobile devices independently posed their respective journals into distributed ledger 210 to cross witness or attest for each other, the simplified illustration of FIG. 2 shows that not all mobile devices have to independently post their journals into the distributed ledger, and not all postings have to be direct from the mobile device to the distributed ledger. In embodiments, depending on the confidence level desired, there might be a sufficiently large subset of the mobile devices performing the independent postings directly or indirectly, and as a result, the reliability of the posted proximity records might nonetheless be considered sufficient to prove a location of a device to allow the location to be considered as a factor for authentication.

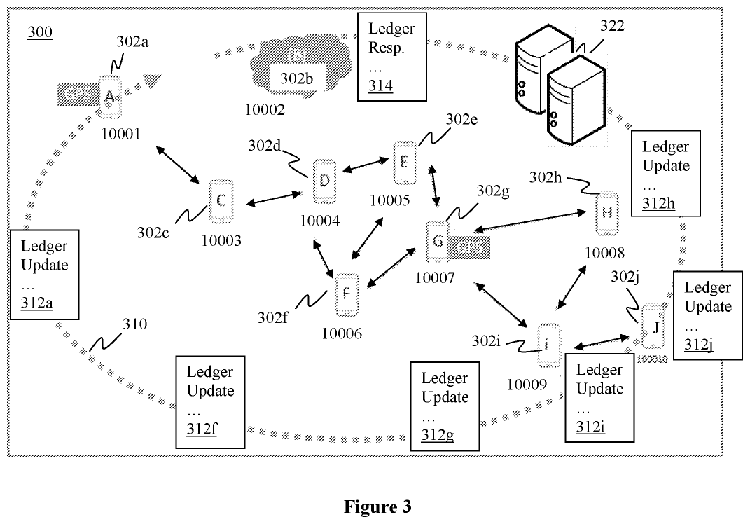

Referring now to FIG. 3, wherein an overview of yet another example computing/communication arrangement with the proof of location technology of the present disclosure, in accordance with various embodiments, is shown. As illustrated, computing/communication environment 300 may include a number of mobile devices 302a and 302c-302j, a stationary device 302b, and a number of servers 322. Mobile devices 302a and 302c-302j may be similar to mobile device 102a-102c or 202a-202c, i.e., located at one set of physical locations at a point in time, and move, and be located in another set of physical locations at another point in time. Further, a subset of the mobile devices, such as mobile device 102a and mobile device 102g may be configured with GPS technology, allowing these devices to be in possession of their geolocations, such as latitude or longitude. Stationary device 302b on the other hand is fixed, which geolocation (e.g., latitude/longitude) at any point in time may be known. Stationary device 302b may be configured to provide product or service to mobile devices 302a and 302c-302j, e.g., location service. Servers 322 may be, similar to servers 122 or 222, configured to jointly host a distributed ledger 310, also graphically denoted as a ring in FIG. 3.

Each of mobile devices 302a and 302c-302j, similar to mobile devices 102a-102c and 202a-202c, may be configured with the proof of location technology of the present disclosure. In particular, each of mobile devices 302a and 302c-302j may be configured to broadcast or share a proximity record with other proximally located devices. Thus, in an instance of time, when different combinations of mobile devices 302a and 302c-302j are proximally located with one another, mobile device 302a may receive proximity records shared by mobile device 302c. Similarly, mobile device 302c may receive proximity records shared by mobile device 302a and mobile device 302d, and mobile device 302d may receive proximity records shared by mobile device 302c, mobile device 302e and mobile device 302f, and so forth. Further, in arrangement 300, since mobile devices 302a and 302g are in possession of their geolocation information, their broadcast/sharing of their proximity records may optionally include their GPS information.

Similar to mobile devices 102a-102c and 202a-202c, each of mobile devices 302a and 302c-302j may be configured to maintain a journal of its broadcast/sharing of its proximity records, and receipts of proximity records of other proximally located devices. In other words, the journal of mobile device 302a may include the journal entries that indicate receipts of proximity records broadcast/shared by mobile device 302c, whereas, the journal of mobile device 302c may include the journal entries that indicate receipts of proximity records broadcast/shared by mobile devices 302a and 302d, the journal of mobile device 302d may include the journal entries that indicate receipts of proximity records broadcast/shared by mobile devices 302c, 302e and 302f, and so forth.

However, unlike computing/communication arrangement 100, but similar to arrangement 200, in arrangement 300, only a subset of mobile devices 302a and 302c-202j would independently post their journals of their broadcast/sharing of their proximity records, and receipts of proximity records of other proximally located devices to distributed ledger 310. For ease of understanding, only mobile devices 302a, 302f, 302g-302j are illustrated as posting ledger updates 312a, 312f and 312g-312j to distributed ledger 310. Additionally, if mobile devices 302a and 302g also included their geolocation information in their proximity records, the posted journal entries of these proximity records would also include the GPS information of mobile devices 302a and 302g.

Thus, in arrangement 300, the proximal location information independently posted into distributed ledger 310 may be used to supplement and strengthen the GPS information of mobile device 302a and 302g in determining the location of mobile devices 302a and 302g.

Further, in arrangement 300, mobile devices 302a and 302c-302j may construct a proximal device graph depicting the proximity relationships of the mobile devices (see example graph 800 of FIG. 8), and provide the proximal device graph to stationary product/service device 302b to prove their locations. On receipt, stationary product/service device 302b may retrieve the underlying proximity records from distributed ledger 310 (e.g., by querying distributing ledger 310 and receiving response 314 from distributed ledger 310) to determine whether mobile devices 302a and 302c-302j have successfully or failed to prove their locations with the proximal device graphs presented.

Those skilled in the art would appreciate that with mobile device 302a and 302g having possession of their geolocation information, it is possible to determine the geolocation information of some of the other mobile devices 302c-302f and 302h-302j, even though they don't have GPS. For example, it is possible to determine the geolocation information of mobile device 302d in view of the geolocation information of mobile device 302a.

Thus, in some embodiments, one or more mobile devices 302a and 302c-302j may additionally practice one or more anonymization technique. In some embodiments, some of mobile devices 302a and 302c-302j may contract with each other to maintain their respective anonymity. For example, mobile device 302d can contract with mobile device 302a not to disclose the geolocation of mobile device 302d as ascertained by mobile device 302a in view of the its own geolocation. As a further example, mobile device 302c may broadcast proximity records with a unique and constantly changing identifier. Thus, the proximity records of mobile device 302c received by mobile devices 302a and 302d, and in turn the journal entries posted by them into distributed ledger 310 will include the constantly changing identifiers of mobile device 302c. Resultantly, none of mobile devices 302a and 302d-302h will be able to build a proximity device graph that tracks mobile device 302c.

In this arrangement, an online service provider, such as service provider 302b may now be able to inspect information about a mobile device 302a, 302c-302j as well as other mobile devices that were proximally observed, including information about those other mobile devices in non-identifying (i.e. anonymous). Information on those other mobile devices may include a token (or some other sort of information) that can be used to “ping” or query those other mobile devices to both verify that those other mobile devices (through a response from those other mobile devices) were observed by the mobile device 302a, and 302c-302j, as well as being able to provide information on still other mobile devices observed by the other mobile devices. By having the devices contain the tokens (or index information) enable others who are observing the distributed ledger (blockchain) with the ability to develop a graph of proximal locations of multiple devices. A non-member user inspecting the distributed ledger (blockchain) will not have a “key” or “token” by which to make sense of the distributed ledger (blockchain) proximal data. Thus, the system of the present disclosure may be both useful and anonymous.

Referring now to FIG. 4, wherein a component view of an example mobile device, in accordance with various embodiments, is illustrated. As shown, mobile device 400, which may be any one of the mobile devices 102a-102c, 202a-202c, 302a or 302c-302j, may include processor and memory 402, proximity circuitry 404, journal circuitry 406, posting circuitry 408, data store 410 and communication circuitry 412, coupled with each other. Communication circuitry 412 may be configured to communicate with one or more other mobile devices, one or more external servers jointly hosting a distributed ledger of proximal device records, and/or one or more servers of one or more product/service providers.

Processor and memory 402 may be configured to execute one or more applications 420, which may use a proximity device graph constructed as earlier described to prove the location of mobile device 400 to a server of a product/service provider, via communication circuitry 412, when engaging in a transaction with the product/service server, e.g., a financial transaction.

Proximity circuitry 404 may be configured to broadcast/share the proximity records of mobile device 400, via communication circuitry 412, as described earlier. In embodiments, proximity circuitry 404 may be configured to construct a proximal device graph 434 based on the journal entries of the sharing and receipt of proximity records 432 stored in data store 410. In embodiments, proximity circuitry 404 stores the constructed proximal device graph 434 in data store 410.

Journal circuitry 406 may be configured to monitor the broadcast/sharing of proximity records of mobile device 400, and receipt of proximity records of other mobile devices, via communication circuitry 412, and journal the broadcast/receipts of the proximity records 432 in data store 410. Posting circuitry 408 may be configured to periodically post, via communication circuitry 412, ledger updates to the distributed ledger of proximity records. Data store 410 may be configured to store the journal entries of proximity records 432, and proximal device graph 434.

Except for their usage, communication circuitry 412, processor and memory 402 and data store 410 may be any one of a number of these elements known in the art. Communication circuitry 412 may be configured to support wireless communication. Examples of wireless communication may include but are not limited to Bluetooth®, WiFi and/or LTE. Processor and memory 402 may be single or multi-core processors, and memory may be volatile or non-volatile memory.

Proximity, journal and/or posting circuitry may be implemented using ASIC or programmable circuits such as FPGA. In alternate embodiments, one or more proximity, journal and/or posting circuitries may be implemented in part or in whole in software or firmware, to be executed by another processor and memory arrangement (not shown) in a separate and/or secure execution environment, or by processor and memory 402.

Referring now FIG. 5, wherein a component view of an example participating host server of a distributed ledger, in accordance with various embodiments, is illustrated. As shown, server 500 may include processor and memory 502, communication circuitry 512 and data store 510. Communication circuitry 512 may be configured to communicate with one or more other mobile devices, and one or more servers of a product or service providers.

Processor and memory 502 may be configured to execute one or more applications, e.g. distributed ledger application 520, which may jointly maintain a distributed ledger of proximity records with other distributed ledger applications on other participating host servers. As described earlier, in some embodiments, distributed ledger application 520 jointly maintains with other distributed ledger applications on other participating host servers, the distributed ledger of proximity records 532 as a blockchain. Data store 410 may be configured to store the journal entries of the proximity records 532 posted by various mobile devices.

Except for their usage, communication circuitry 512, processor and memory 502 and data store 510 may be any one of a number of these elements known in the art. Communication circuitry 512 may be configured to support wired and/or wireless communication. Examples of wired communication may include, but are not limited to, universal serial bus (USB) or Ethernet. Examples of wireless communication may include but are not limited to Bluetooth®, WiFi and/or LTE. Processor and memory 502 may be single or multi-core processors, and memory may be volatile or non-volatile memory.

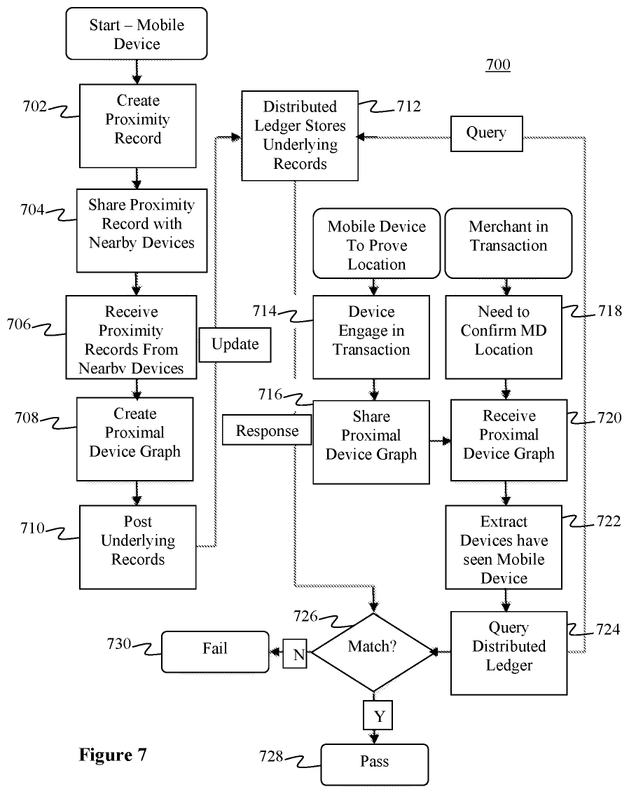

Referring now to FIG. 6, wherein a component view of an example server of a product or service provider, in accordance with various embodiments, is illustrated. As shown, server 600 may include processor and memory 602, and communication circuitry 612. Communication circuitry 612 may be configured to communicate with one or more other mobile devices, and one or more external servers jointly hosting a distributed ledger of proximal device records. Processor and memory 602 may be configured to execute one or more applications, e.g. merchandizing or financial application 620, which may engage in transactions with one or more mobile devices to provide product and/or services to the mobile devices, e.g., financial services. An example process for proving location using the technology of the present disclosure, to engage in a transaction, such as a financial transaction, will be described below with references to FIG. 7.

Except for their usage, communication circuitry 612, and processor and memory 602 may be any one of a number of these elements known in the art. Communication circuitry 612 may be configured to support wired and/or wireless communication. Examples of wired communication may include, but are not limited to, universal serial bus (USB) or Ethernet. Examples of wireless communication may include but are not limited to Bluetooth®, WiFi and/or LTE. Processor and memory 602 may be single or multi-core processors, and memory may be volatile or non-volatile memory.

Referring now to FIG. 7, wherein an example process for proving location, in accordance with various embodiments, is shown. Process 700 for proving location may include operations performed at blocks 702-730. In embodiments, the operations at blocks 702-710 and 714-716 may be performed e.g., by a mobile device, in particular, the various components of mobile device 400 of FIG. 4. The operations at block 712 may be performed e.g., by a server, in particular, the various components of server 500 of FIG. 5. The operations at blocks 718-730 may be performed e.g., by a server, in particular, the various components of server 600 of FIG. 6. In alternate embodiments, some of the operations may be divided or combined, or performed in different order.

Process 700 may start at block 702. At block 702, a proximity record may be created for a mobile device, by the mobile device. Next, at block 704, on creation, the proximity record may be shared, e.g., by the mobile device, with other devices proximally located near the mobile device. The sharing of the proximity record of the mobile device may be journal. At block 706, proximity records of the proximally located mobile devices may be received by the mobile device. Similarly, the receipt of the proximity records of the proximally located mobile devices may be journal.

At block 708, a proximal device graph of the proximal devices of a mobile device may be constructed for the mobile device, by the mobile device. At block 710, the underlying proximity records of the proximal device graph, i.e., the journal entries of the sharing and receiving of proximity records, may be posted to a distributed ledger, which may store the posted entries.

At block 714, when a mobile device may enter into an engagement with a server of a product or service provider to transact for products and/or services. At block 716, the mobile device may share its proximal device graph with the server of the product or service provider to prove its location.

At block 718, the server of the provider or service provider may identify a need to confirm the mobile device's location in order to complete the transaction for product or service with the mobile device. At block 720, the proximal device graph of the mobile device may be received by the server of the product or service provider. At block 722, the server may extract from the proximal device graph, the proximal devices seen by the mobile device. At block 724, the server may query the distributed ledger of proximity records to obtain the underlying record to confirm the location of the mobile device.

At block 726, a determination is made on whether the proximal devices seen by the mobile device extracted from the proximal device graph matches the proximal devices seed by the mobile device as reflected from the proximity records provided by the distributed ledger. From block 726, process 700 either proceeds to block 728 or block 730. If a result of the determination indicates the two sets of information match one another, at block 728, the location of the mobile device may be considered successfully proven. On the other hand, if the result of the determination indicates the two sets of information do not fully match, at block 730, the location of the mobile device may be considered not proven.

Example use case scenarios.

In a first example use case scenario, a user might to interact with a bank to transfer some of the user's fund. It would be beneficial in the bank's trust calculation if the bank knew the transaction was originating at the physical street address associated with the account. Existing methods may not be sufficiently reliable or can be trusted, because the information is provided by a third party without a vested interest in the transaction. For example, the location is often established by a centralized service under a single administrative control (such as Apple® or Google®). Using the techniques disclosed herein, the user's location might be considered more reliable or trustworthy, with the user demonstrating knowledge of the proximally located device, which is verified against proximity records independently posted to a distributed ledger.

In another example use case scenario, within a user's neighborhood it would be helpful if the user could see a listing of items for sale that are nearby, or garage sales, or neighborhood gathering where the user can be assured that the information was posted from a device located in the neighborhood. Currently, it is not not possible for typical users with typical devices to provide a reliable (trusted and secure) location-based web service or IoT device that has a GEO fence capability. Using the techniques disclosed herein, the user may have higher confidence and trust that the information is posted by devices located in the neighborhood.

As still another use case scenario, the disclosed technique may be employed to establish proof of proximity with autonomous vehicles, IoT devices etc.

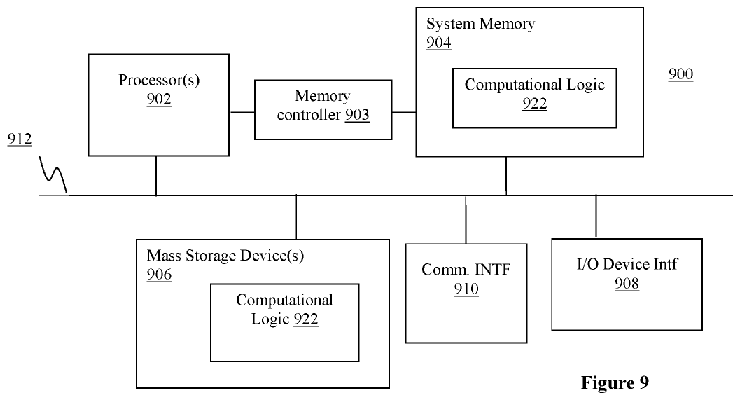

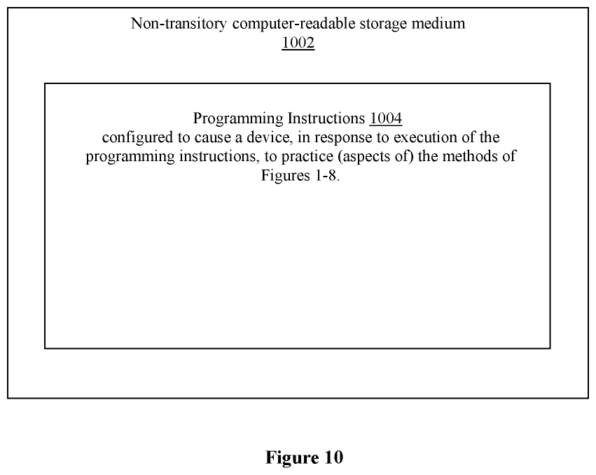

Referring now to FIG. 9, wherein a block diagram of a computer device suitable for use a mobile device, a server to join with other server to host the distributed ledger of proximity records, or a server to provide product or service, in accordance with various embodiments, is illustrated. As shown, computer device 900 may include one or more processors 902, memory controller 903, system memory 904 and communication interface 910. Processor 902 may be any microcontroller, single core or multi-core processors known in the art, memory controller 903 and system memory 904 may include any known memory controllers, and volatile or non-volatile memory. Similarly, communication interfaces 910 may be any known communication interfaces (such as network interface cards) configured to support wired and/or wireless communication.

Additionally, in embodiments, computer device 900 may further include optional mass storage device(s) 906 (such as solid state drives), and/or input/output device interface 908 (to interface with various input/output devices, such as, mouse, cursor control, display device (including touch sensitive screen), and so forth). The elements may be coupled to each other via system bus 912, which may represent one or more buses. In the case of multiple buses, they may be bridged by one or more bus bridges (not shown).

Each of these elements may perform its conventional functions known in the art. In particular, system memory 904 and/or mass storage device(s) 906 may be employed to store a working copy and/or a permanent copy of the executable code of the programming instructions of software implementations of aspects of or entirety of proximity circuitry 404, journal circuitry 406, posting circuitry 408, application 420, distributed ledger application 520, and/or merchandizing or financial application 620, collectively referred to as computing logic 922. The programming instructions may comprise assembler instructions supported by processor(s) 902 or high-level languages, such as, for example, C, that can be compiled into such instructions.

The permanent copy of the executable code of the programming instructions may be placed into storage device(s) 904 and/or 906 in the factory, or in the field, through, for example, a distribution medium (not shown), such as a compact disc (CD), or through communication interface 910 (from a distribution server (not shown)).

The number, capability and/or capacity of these elements 910-912 may vary, depending on the intended use of example computer device 900, e.g., whether example computer device 900 is used as a mobile device 102a-102c, 202a-202c, 302a, or 302c-302j, a server 122, 222 or 322 to join with other server to host the distributed ledger of proximity records, or a server 302b to provide product or service. The constitutions of these elements 910-912 are otherwise known, and accordingly will not be further described.

FIG. 10 illustrates an example storage medium with instructions configured to enable a mobile device, a server to join with other server to host the distributed ledger of proximity records, or a server to provide product or service, to practice all or selected ones of the operations associated with these devices, earlier described, in accordance with various embodiments. As illustrated, non-transitory computer-readable storage medium 1002 may include the executable code of a number of programming instructions 1004. Executable code of programming instructions 1004 may be configured to enable a device, e.g., a mobile device 102a-102c, 202a-202c, 302a, or 302c-302j, a server 122, 222 or 322 to join with other server to host the distributed ledger of proximity records, or a server 302b to provide product or service, in response to execution of the executable code/programming instructions, to perform, e.g., various operations associated with these devices, described with references to FIGS. 1-8. In alternate embodiments, executable code/programming instructions 1004 may be disposed on multiple non-transitory computer-readable storage medium 1002 instead. In still other embodiments, executable code/programming instructions 1004 may be encoded in transitory computer readable medium, such as signals.

In embodiments, a processor may be packaged together with a computer-readable storage medium having some or all of executable code of programming instructions 1004 configured to practice all or selected ones of the operations earlier described with references to FIG. 1-8. For one embodiment, a processor may be packaged together with such executable code 1004 to form a System in Package (SiP). For one embodiment, a processor may be integrated on the same die with a computer-readable storage medium having such executable code 1004. For one embodiment, a processor may be packaged together with a computer-readable storage medium having such executable code 1004 to form a System on Chip (SoC). For at least one embodiment, the SoC may be utilized in, e.g., a mobile device 102a-102c, 202a-202c, 302a, or 302c-302j, a server 122, 222 or 322 to join with other server to host the distributed ledger of proximity records, or a server 302b to provide product or service.

Thus, an improved method, apparatus or computer-readable medium for proving a location has been described. Example embodiments of the method, apparatus or computer-readable medium may include:

Example 1 may be an apparatus for computing, comprising: communication circuitry to communicate with one or more external servers jointly hosting a distributed ledger of proximal device records; and posting circuitry coupled with the communication circuitry to post records of sharing of a proximity record of the apparatus with one or more other apparatuses located proximally to the apparatus, and records of receipts of proximity records of the other proximally located apparatuses from the other proximally located apparatuses, into the distributed ledger. The proximity records posted into the distributed ledger may be used to prove the apparatus's location.

Example 2 may be example 1, further comprising proximity circuitry coupled with the communication circuitry to share the proximity record of the apparatus with the one or more other apparatuses located proximally to the apparatus.

Example 3 may be example 2, wherein the proximity circuitry may further construct a proximal device graph, based at least in part on the shared proximity record of the apparatus with the one or more other apparatuses located proximally to the apparatus, and the received proximity records of the other proximally located apparatuses.

Example 4 may be example 1, further comprising journal circuitry coupled with the communication circuitry to journal the sharing of the proximity record of the apparatus with the one or more other apparatuses located proximally to the apparatus, and journal the receipts of the proximity records of the other proximally located apparatuses from the other proximally located apparatuses.

Example 5 may be example 4, further comprising a data store coupled with the journal circuitry, the journal circuitry journals into the data store the sharing of the proximity record of the apparatus with the one or more other apparatuses located proximally to the apparatus, and the receipts of the proximity records of the other proximally located apparatuses from the other proximally located apparatuses, into the data store.

Example 6 may be example 5, wherein the posting circuitry may be further coupled to the data store and retrieve the journaled sharing of the proximity record of the apparatus with the one or more other apparatuses located proximally to the apparatus, and the journaled receipts of the proximity records of the other proximally located apparatuses from the other proximally located apparatuses, from the data store.

Example 7 may be example 1, wherein the proximity records of the apparatus and the other proximally located apparatuses may respectively include identifier tokens of the apparatus and the other proximally located apparatuses.

Example 8 may be example 7, wherein the proximity records may be encrypted.

Example 9 may be example 1, further comprising a processor, and an application operated by the processor, wherein the application provides a proximity device graph, constructed based at least in part on the proximity records, to a server of a product or service provider, to prove the apparatus' location.

Example 10 may be any one of examples 1-9, wherein the apparatus is a mobile device.

Example 11 may be a method for an apparatus to prove its location, comprising: creating, by the apparatus, a proximity record of the apparatus; sharing, by the apparatus, the proximity record of the apparatus with other apparatuses located proximally to the apparatus; receiving, by the apparatus, proximity records of the other proximally located apparatuses from the other proximally located apparatuses; and posting, by the apparatus, the sharing of the proximity record of the apparatus, and the receipts of the proximity records of the other proximally located apparatuses from the other proximally located apparatuses into a distributed ledger jointly hosted by a plurality of servers external to the apparatus. The proximity records posted into the distributed ledger may be used to prove the location of the apparatus.

Example 12 may be example 11, further comprising constructing a proximal device graph, based at least in part on the shared proximity record of the apparatus with the one or more other apparatuses located proximally to the apparatus, and the received proximity records of the other proximally located apparatuses.

Example 13 may be example 11, further comprising journaling the sharing of the proximity record of the apparatus with the one or more other apparatuses located proximally to the apparatus, and journal the receipts of the proximity records of the other proximally located apparatuses from the other proximally located apparatuses.

Example 14 may be example 13, wherein posting may comprise retrieving the journaled sharing of the proximity record of the apparatus with the one or more other apparatuses located proximally to the apparatus, and the journaled receipts of the proximity records of the other proximally located apparatuses from the other proximally located apparatuses.

Example 15 may be any one of examples 11-14, wherein the proximity records of the apparatus and the other proximally located apparatuses respectively include identifier tokens of the apparatus and the other proximally located apparatuses.

Example 16 may be at least one computer readable media (CRM) comprising a plurality of instructions arranged to cause an apparatus, in response to execution of the instructions by the apparatus, to: create a proximity record of the apparatus; share the proximity record of the apparatus with other apparatuses located proximally to the apparatus; receive proximity records of the other proximally located apparatuses from the other proximally located apparatuses; and post the sharing of the proximity record of the apparatus, and the receipts of the proximity records of the other proximally located apparatuses from the other proximally located apparatuses into a distributed ledger jointly hosted by a plurality of servers external to the apparatus. The proximity records posted into the distributed ledger may be used to prove the location of the apparatus.

Example 17 may be example 16, further comprising constructing a proximal device graph, based at least in part on the shared proximity record of the apparatus with the one or more other apparatuses located proximally to the apparatus, and the received proximity records of the other proximally located apparatuses.

Example 18 may be example 16, further comprising journaling the sharing of the proximity record of the apparatus with the one or more other apparatuses located proximally to the apparatus, and journal the receipts of the proximity records of the other proximally located apparatuses from the other proximally located apparatuses.

Example 19 may be example 16, wherein posting may comprise retrieving the journaled sharing of the proximity record of the apparatus with the one or more other apparatuses located proximally to the apparatus, and the journaled receipts of the proximity records of the other proximally located apparatuses from the other proximally located apparatuses.

Example 20 may be any one of examples 16-19, wherein the proximity records of the apparatus and the other proximally located apparatuses respectively include identifier tokens of the apparatus and the other proximally located apparatuses.

Example 21 may be an apparatus for proving the apparatus' location, comprising: means for creating a proximity record of the apparatus; means for sharing the proximity record of the apparatus with other apparatuses located proximally to the apparatus; means for receiving proximity records of the other proximally located apparatuses from the other proximally located apparatuses; and means for posting the sharing of the proximity record of the apparatus, and the receipts of the proximity records of the other proximally located apparatuses from the other proximally located apparatuses into a distributed ledger jointly hosted by a plurality of servers external to the apparatus. The proximity records posted into the distributed ledger may be used to prove the location of the apparatus.

Example 22 may be example 21, further comprising means for constructing a proximal device graph, based at least in part on the shared proximity record of the apparatus with the one or more other apparatuses located proximally to the apparatus, and the received proximity records of the other proximally located apparatuses.

Example 23 may be example 21, further comprising means for journaling the sharing of the proximity record of the apparatus with the one or more other apparatuses located proximally to the apparatus, and means for journaling the receipts of the proximity records of the other proximally located apparatuses from the other proximally located apparatuses.

Example 24 may be example 23, wherein means for posting may comprise means for retrieving the journaled sharing of the proximity record of the apparatus with the one or more other apparatuses located proximally to the apparatus, and the journaled receipts of the proximity records of the other proximally located apparatuses from the other proximally located apparatuses.

Example 25 may be any one of examples 21-24, wherein the proximity records of the apparatus and the other proximally located apparatuses respectively include identifier tokens of the apparatus and the other proximally located apparatuses.

Example 26 may be a server for jointly hosting with other servers a distributed ledger of proximity records, comprising: communication circuitry to communicate with an apparatus; storage to store some of the proximity records; and distributed ledger circuitry coupled to the communication circuitry and the storage to store into the storage, a record of sharing of a proximity record of the apparatus, and records of receipts of proximity records of other apparatuses proximally located to apparatus, by the apparatus, from the other proximally located apparatuses posted by the apparatus into the distributed ledger. The proximity records posted into the distributed ledger by the apparatus may be used to prove the location of the apparatus.

Example 27 may be example 26, wherein the distributed ledger circuitry may further provide, in response to a query of a server of product or service provider, the stored record of sharing of a proximity record of the apparatus, and the stored records of receipts of proximity records of other apparatuses proximally located to apparatus, by the apparatus, from the other proximally located apparatuses.

Example 28 may be a method for a server to jointly host with other servers a distributed ledger of proximity records, comprising: receiving, by the server, from an apparatus, posting of a record of sharing of a proximity record of the apparatus, and posting of records of receipts of proximity records of other apparatuses proximally located to apparatus, by the apparatus, from the other proximally located apparatuses, into the distributed ledger; and storing into a storage, by the server, the proximity records. The proximity records posted into the distributed ledger by the apparatus may be used to prove the location of the apparatus.

Example 29 may be example 28, further comprising providing, in response to a query of a server of product or service provider, the stored record of sharing of a proximity record of the apparatus, and the stored records of receipts of proximity records of other apparatuses proximally located to apparatus, by the apparatus, from the other proximally located apparatuses.

Example 30 may at least one computer readable media (CRM) comprising a plurality of instructions arranged to cause a server, in response to execution of the instructions by the server, to jointly host with other servers a distributed ledger of proximity records, including to: receive, from a device, posting of a record of sharing of a proximity record of the device, and posting of records of receipts of proximity records of other apparatuses proximally located to device, by the device, from the other proximally located devices, into the distributed ledger; and store into a storage the proximity records. The proximity records posted into the distributed ledger by the device may be used to prove the location of the device.

Example 31 may be example 30, wherein the server is further caused to provide, in response to a query of a server of product or service provider, the stored record of sharing of a proximity record of the device, and the stored records of receipts of proximity records of other devices proximally located to the device, by the device, from the other proximally located devices.

Example 32 may be an apparatus to jointly host with other servers a distributed ledger of proximity records, comprising: means for receiving, from a device, posting of a record of sharing of a proximity record of the device, and posting of records of receipts of proximity records of other devices proximally located to the device, from the other proximally located devices, into the distributed ledger; and means for storing the proximity records. The proximity records posted into the distributed ledger by the device may be used to prove the location of the device.

Example 33 may be example 32, further comprising means for providing, in response to a query of a server of product or service provider, the stored record of sharing of a proximity record of the device, and the stored records of receipts of proximity records of other devices proximally located to the device, from the other proximally located devices.

Example 34 may be a server for providing a product or service, comprising transaction circuitry coupled to the communication circuitry to conduct a transaction with the apparatus, the transaction circuitry is to receive a proximity device graph from the apparatus, and to retrieve proximity records underlying the proximity device graph, from one or more servers jointly hosting a distributed ledger of proximity records, to prove the device's location. The device, prior to the transaction, posted the underlying proximity records to the distributed ledger.

Example 35 may be example 34, wherein the underlying records include a record of sharing of a proximity record of the device with other devices proximally located to device, and records of receipts of proximity records of the other devices proximally located to the device, by the device, from the other proximally located apparatuses.

Example 36 may be example 34 or 35, wherein to conduct a transaction may comprise to conduct a financial transaction.

Example 37 may be a method for providing a product or service, comprising: engaging, by a server, a device to conduct a transaction; receiving, by the server, from the device, a proximity device graph to prove the apparatus' location; receiving, by the server, from one or more servers that jointly host a distributed ledger of proximity records, underlying proximity records of the proximity device graph; and determining, by the server, whether the device has proved its location with the proximity device graph, based at least in part on the underlying proximity records received from the one or more servers that jointly host the distributed ledger of proximity records. The device, prior to the transaction, posted the underlying proximity records to the distributed ledger.

Example 38 may be example 37, further comprising completing, by the server, the transaction with the device, on determining that the apparatus has proved its location with the proximity device graph

Example 39 may be example 37 or 38, wherein engaging a transaction may comprise engaging the device in a financial transaction.

Example 40 may be at least one computer readable media (CRM) comprising a plurality of instructions arranged to cause a server, in response to execution of the instructions by the server, to provide a product or server, including to: engage a device to conduct a transaction; receive from the device, a proximity device graph to prove the device′ location; receive from one or more servers that jointly host a distributed ledger of proximity records, underlying proximity records of the proximity device graph; and determine whether the device has proved its location with the proximity device graph, based at least in part on the underlying proximity records received from the one or more servers that jointly host the distributed ledger of proximity records. The device prior to the transaction, posted the underlying proximity records to the distributed ledger.

Example 41 may be example 40, wherein the server may be further caused to complete the transaction with the device, on determination that the device has proved its location with the proximity device graph

Example 42 may be example 40 or 41, wherein to conduct a transaction may comprise to conduct a financial transaction.

Example 43 may be an apparatus for providing a product or service, comprising: means for engaging a device to conduct a transaction; means for receiving, from the device, a proximity device graph to prove the apparatus' location; means for receiving, from one or more servers that jointly host a distributed ledger of proximity records, underlying proximity records of the proximity device graph; and means for determining, whether the device has proved its location with the proximity device graph, based at least in part on the underlying proximity records received from the one or more servers that jointly host the distributed ledger of proximity records. The device, prior to the transaction, posted the underlying proximity records to the distributed ledger.

Example 44 may be example 43, wherein the means for engaging completes the transaction with the device, on determining that the device has proved its location with the proximity device graph.

Example 45 may be example 43 or 44, wherein to conduct a transaction may comprise to conduct a financial transaction.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

1-20. (canceled)

21. A server for jointly hosting with other servers a distributed ledger of proximity records, comprising:
communication circuitry to communicate with an apparatus;
storage to store some of the proximity records; and
distributed ledger circuitry coupled to the communication circuitry and the storage to store into the storage, a record of sharing of a proximity record of the apparatus, and records of receipts of proximity records of other apparatuses proximally located to apparatus, by the apparatus, from the other proximally located apparatuses posted by the apparatus into the distributed ledger;
wherein the proximity records posted into the distributed ledger by the apparatus are used to prove the location of the apparatus.

22. The server of claim 21, wherein the distributed ledger circuitry is to further provide, in response to a query of a server of product or service provider, the stored record of sharing of a proximity record of the apparatus, and the stored records of receipts of proximity records of other apparatuses proximally located to apparatus, by the apparatus, from the other proximally located apparatuses.

23. A server for providing a product or service, comprising:
communication circuitry to communicate with a device; and
transaction circuitry coupled to the communication circuitry to conduct a transaction with the device, the transaction circuitry is to receive a proximity device graph from the device, and to retrieve proximity records underlying the proximity device graph, from one or more servers jointly hosting a distributed ledger of proximity records, to prove the device's location;
wherein the device, prior to the transaction, posted the underlying proximity records to the distributed ledger.

24. The server of claim 23, wherein the underlying records include a record of sharing of a proximity record of the device with other devices proximally located to the device, and records of receipts of proximity records of the other devices proximally located to the device, by the device, from the other proximally located devices.

25. (canceled)

26. The server of claim 23, wherein the distributed ledger is implemented as a blockchain.

27. The server of claim 23, wherein the server further can query the device using a token included in the distributed ledger.

28. The server of claim 27, wherein the token is first received from the device with the underlying proximity records and the device, prior to the transaction, posted the token to the distributed ledger.

29. The server of claim 23, wherein the server is to complete the transaction with the device on determining that the device has proved its location with the proximity device graph.

30. One or more non-transitory computer readable media (CRM) comprising a plurality of instructions arranged to cause a server, in response to execution of the instructions by the server, to:
jointly host with other servers a distributed ledger of proximity records, including to:
receive, from a device, posting of a record of sharing of a proximity record of the device, and posting of records of receipts of proximity records of other apparatuses proximally located to device, by the device, from the other proximally located devices, into the distributed ledger; and store into a storage the proximity records,
wherein the proximity records posted into the distributed ledger by the device are used to prove the location of the device.

31. The CRM of claim 30, wherein the instructions are to further cause the server to provide, in response to a query of a server of product or service provider, the stored record of sharing of a proximity record of the device, and the stored records of receipts of proximity records of other devices proximally located to the device, by the device, from the other proximally located devices.

32. The CRM of claim 30, wherein the instructions are to further cause the server to implement the distributed ledger using a blockchain

33. One or more non-transitory computer readable media (CRM) comprising a plurality of instructions arranged to cause a server, in response to execution of the instructions by the server, to:
engage a device to conduct a transaction;
receive from the device, a proximity device graph to prove the device's location;
receive from one or more servers that jointly host a distributed ledger of proximity records, underlying proximity records of the proximity device graph; and
determine whether the device has proved its location with the proximity device graph, based at least in part on the underlying proximity records received from the one or more servers that jointly host the distributed ledger of proximity records,
wherein the device, prior to the transaction, posted the underlying proximity records to the distributed ledger.

34. The CRM of claim 33, wherein the underlying records include a record of sharing of a proximity record of the device with other devices proximally located to the device, and records of receipts of proximity records of the other devices proximally located to the device, by the device, from the other proximally located devices.

35. The CRM of claim 33, wherein the instructions are to further cause the server to query the device using a token included in the distributed ledger.

36. The CRM of claim 35, wherein the instructions are to further cause the server to first receive, from the device, the token with the underlying proximity records prior to the transaction, and post the token to the distributed ledger.

37. The CRM of claim 33, wherein the instructions are to further cause the apparatus to implement the distributed ledger using a blockchain.

38. The CRM of claim 33, wherein the server is to complete the transaction with the device on determining that the device has proved its location with the proximity device graph.

39. The server of claim 21, wherein the distributed ledger is implemented using a blockchain.
